(19) United States
(12) Patent Application Publication
(10) Pub. No.: US 2004/0006526 A1
(43) Pub. Date: Jan. 8, 2004

(54) Stock exchange method via substitute investor in cyberspace

(76) Inventor: Ki-Pyo Ihm, Seoul (KR)

Correspondence Address: Don W Bulson, Renner Otto Boisselle & Sklar, 19th Floor, 1621 Euclid Avenue, Cleveland, OH, 44115, US

(21) Appl. No.: 10/344,108

(22) PCT Filed: Aug. 7, 2001
(86) PCT No.: PCT/KR01/01342

(30) Foreign Application Priority Data
Aug. 8, 2000 (KR) 2000/4586.3

(51) Int. Cl. G06F 17/60

(52) U.S. Cl. 705/37; 705/36

(57) ABSTRACT

The present invention relates to a method for stock exchange via substitute investor in cyberspace, wherein an investor qualified as capital investor in cyberspace appoints any one or a plurality of substitute investor(s), who is (are) qualified as substitute investor, and supplies investment money to the substitute investors._ By doing this said substitute investors can invest on behalf of the capital investor and the substitute investor should pay a predetermined amount of profit gained by substitute investment to the capital investor. And using the method for stock exchange via substitute investor in cyberspace of the present invention can save time spent for stock investment, prevent inattentiveness at a job site, and reduce anxiety caused by stock trading.

### TECHNICAL FIELD

The present invention relates to a method for stock exchange via substitute investor in cyberspace, and in particular to a method for stock exchange via substitute investor in cyberspace where a capital investor appoints a plurality of substitute investors entitling them to invest by proxy, by which a capital investor can save time spent for stock investment, prevent inattentiveness at a job site, and reduce anxiety caused by stock trading.

### BACKGROUND OF THE INVENTION

Generally, due to increasing supply of the internet, stock trading in cyberspace, i.e. on-line stock trading is gradually expanding. As stock exchange in cyberspace becomes general, many people such as office workers, public service personnel, students and housewives are participating in cyber stock trading, the public are concentrating on daily stock prices, and the rise and fall of stock prices instigates investor's joys and sorrows.

But, this kind of sensational boom of expanding cyber stock trading is causing severe social or personal problems in that fanatic investors who are obsessively trading during office working hours are gradually increasing, and the obsessive investors feel anxiety if the stock list is out of sight, which leads to big troubles in official work and inattentiveness at a job site.

And as social awareness on stock investment increases, imprudent beginners are participating in stock trading, which leads to increasing stock investment failure, causing the stock trader sleeping disturbance, weight loss, decrease of appetite, anthrophobia, and even psychological disorder such as depression.

And also other socio-pathologic problems such as alienation from people who has no room for stock trading rampantly appear and disappear due to stock trading.

### DISCLOSURE OF INVENTION

The present invention is provided to solve said problems, and an objectives of the present invention is to provide a method for stock exchange via substitute investor in cyberspace where a capital investor appoints a plurality of substitute investors entitling them to trade by proxy.

As technical means to achieve said objectives of the present invention, the method of this invention is characterized in including a first step of connecting to a web server; a second step for a non-registered customer to register and for a registered customer to proceed to a next step; a third step of processing log-in of a registered customer; a forth step of connecting to a real-time stock exchange system at the request of investment start; a fifth step including information search step for searching stock related information and data on substitute investors, substitute investor appointment step for appointing a substitute investor, stock exchange step for a substitute investor appointed by a capital investor to trade stocks, substitute investor administration step for administering trading information of substitute investor of each capital investor; and a sixth step for determining exit, wherein if there is no exit order, the flow goes back to said fifth step, otherwise finishes connecting to the web server.

### BRIEF DESCRIPTION OF THE DRAWINGS

FIG. 1 is a schematic illustration of a stock exchange system of the present invention.

FIG. 2 is a schematic block diagram illustrating a stock exchange server 33 of FIG. 1.

FIG. 3 is a schematic block diagram illustrating database 35 of FIG. 1.

FIG. 4 is a flow chart illustrating a stock exchange method according to the present invention.

FIG. 5 shows a graphic user interface provided when logging in the web server of FIG. 2.

FIG. 6 is a flow chart illustrating a process for new registration of FIG. 2.

FIG. 7 shows a graphic user interface provided when selecting start investment of FIG. 4.

FIG. 8 is a detailed flow chart illustrating stock exchange and information search of FIG. 4.

FIG. 9 is an exemplary list of substitute investors.

FIG. 10 is an exemplary list of limit of investment money of substitute investors of each class.

FIG. 11 is an exemplary list of stock investors.

FIGS. 12a and 12b are exemplary investment breakdown of substitute investors.

FIG. 13 is an exemplary investment breakdown of sub-substitute investors.

### BEST MODE FOR CARRYING OUT THE INVENTION

A system for stock exchange via substitute investor in cyberspace according to the present invention is described in detail as follows referring to attached drawings. Each element of the present invention practically having the same constitution and function is described using identical element numbers.

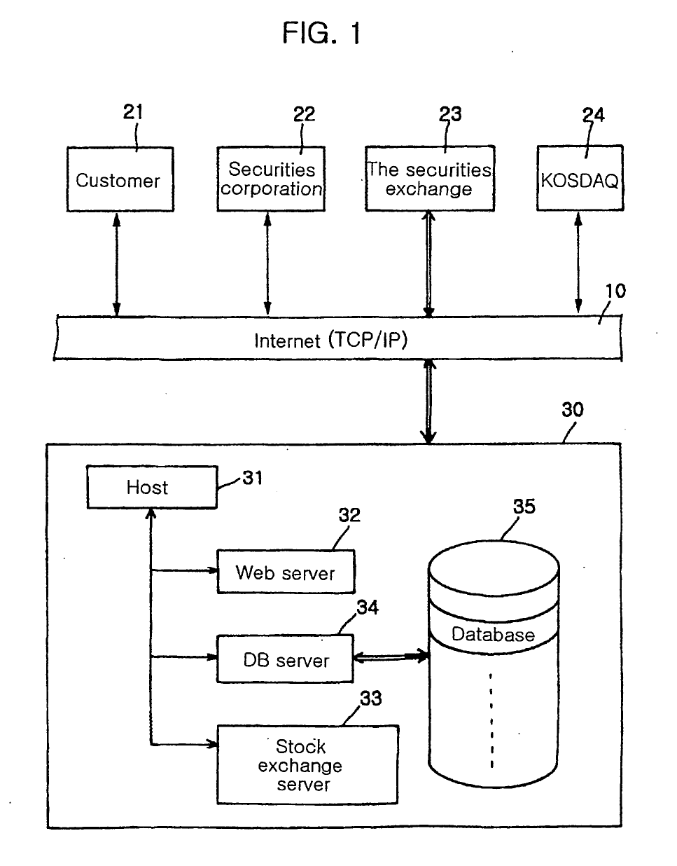

FIG. 1 is a schematic illustration of a stock exchange system of the present invention, and referring to FIG. 1, the stock exchange system 30 via substitute investor in cyberspace comprises a host 31 that comprehensively controls each server for stock exchange in the internet 10, a web server 32 for providing web pages required for stock exchange, a stock exchange server 33 for searching information through the internet 10, registering a substitute investor, processing stock trading and administering data on substitute investors, a DB server 35(34?) for storing and providing information in cooperation with said web server 32 and stock exchange server 33, and database 35 for storing information on customers, capital investors and substitute investors.

The stock exchange system 30 of the present invention, as described above, permits a customer 21 to access to the stock exchange system through the internet 10 and a securities corporation 22, the Securities Exchange 23 and Kosdaq 24 can access to the system. Through interconnection between the stock exchange system 30 of the present invention and a securities corporation 22, the Securities Exchange 23 and Kosdaq 24, a customer is provided with sufficient environment for stock exchange getting information on stocks.

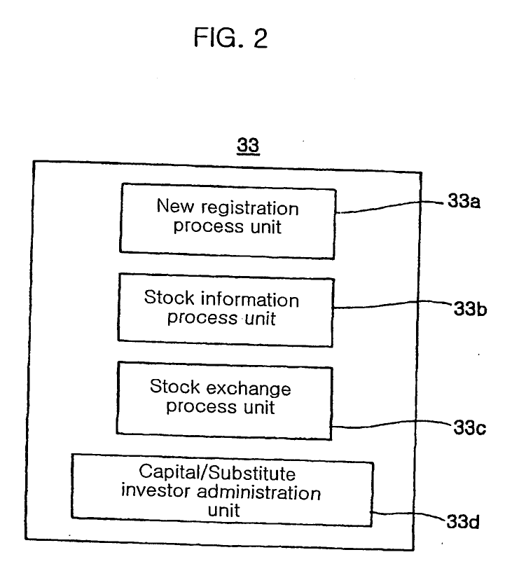

FIG. 2 is a schematic block diagram illustrating the stock exchanging server 33 of FIG. 1, and referring to FIG. 2, said stock exchange server 33 comprises new registration processing unit 33a for processing registration of new customer, stock information process unit 33b for providing information on stocks, stock exchange processing unit 33c for processing stock trading when start investment is selected and capital/substitute investor administration unit 33d for connecting and registering a capital/substitute investor and for administering data on substitute investors.

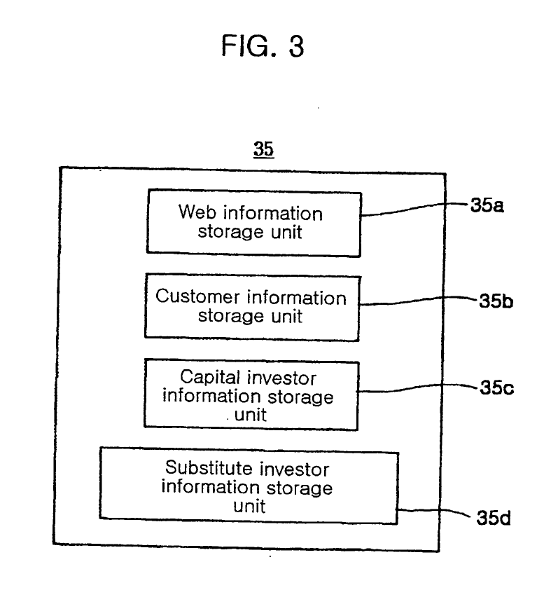

FIG. 3 is a schematic block diagram illustrating the database 35 of FIG. 1, and referring to FIG. 3, said database 35 comprises web information storage unit 35a for storing data required for proving web pages, customer information storage unit 35b for storing customer information, capital investor information storage unit 35c for storing information on capital investors, substitute investor information storage unit 35d for storing information on substitute investors.

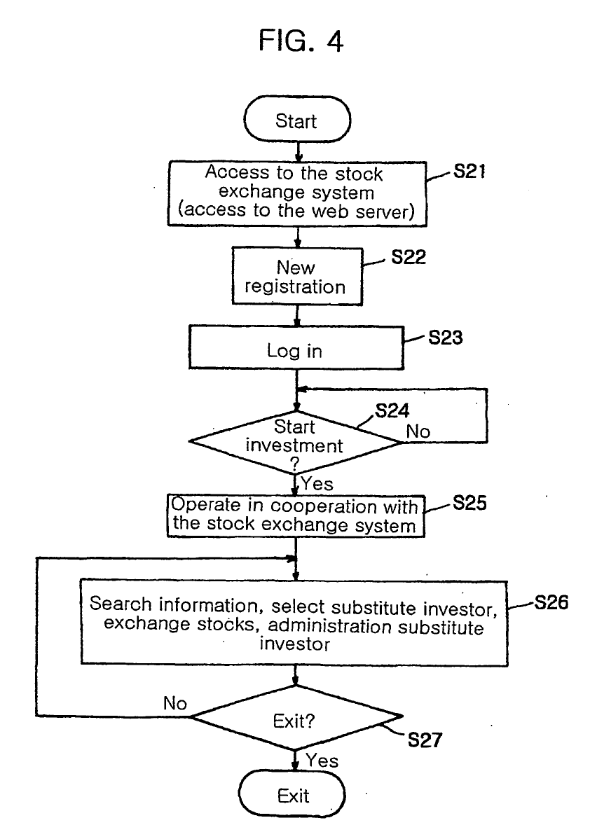

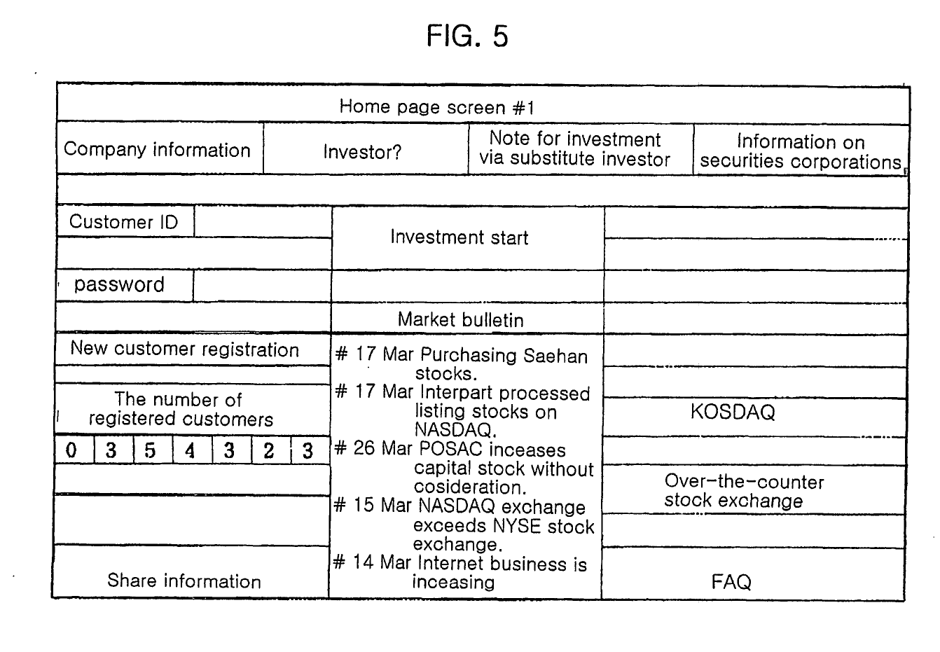

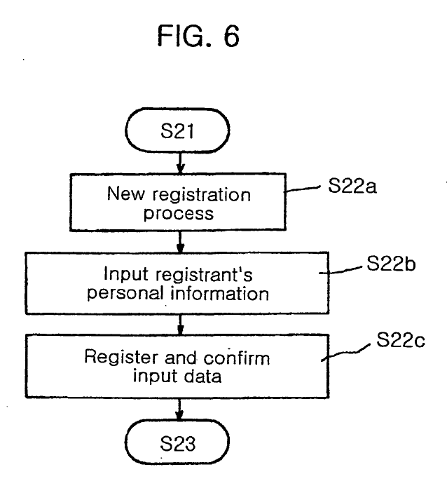

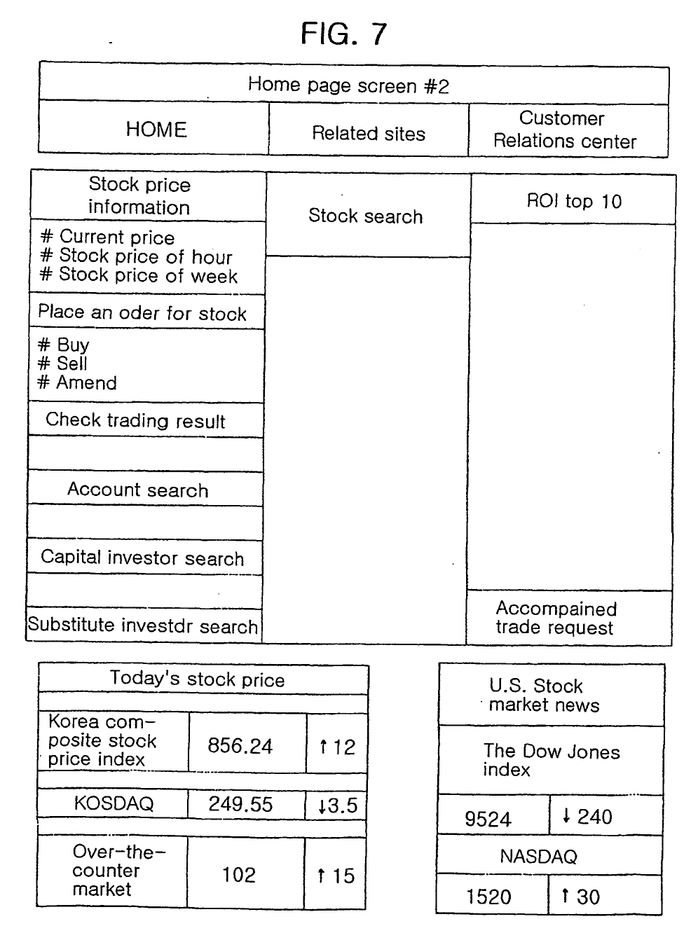

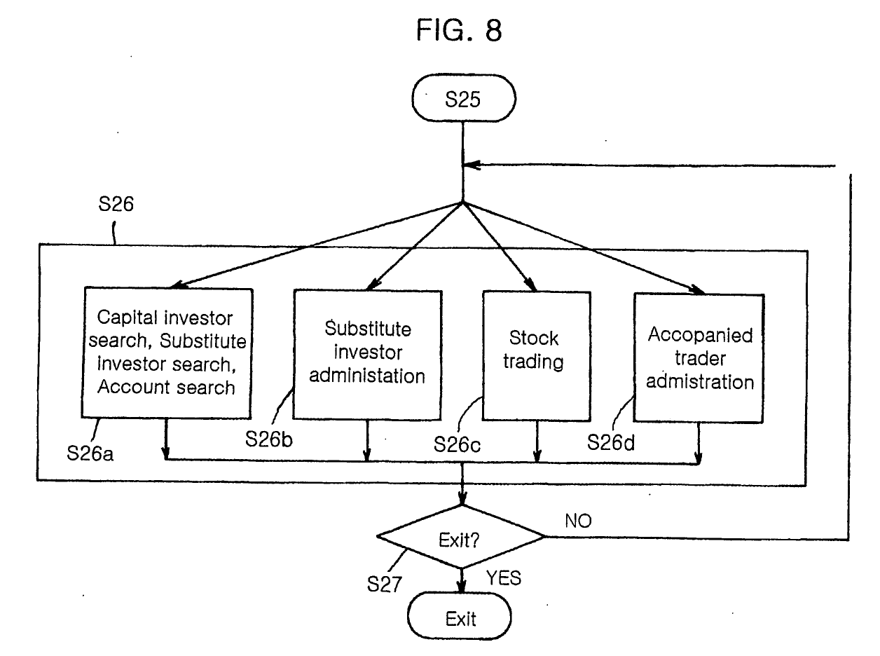

FIG. 4 is a flow chart illustrating a stock exchange method according to the present invention, and FIG. 5 shows a graphic user interface provided when logging in the web server of FIG. 2, where various stock information such as stock market information is provided and variety of functions relating to stock exchange including customer registration are available. FIG. 6 is a flow chart illustrating a process for new registration of FIG. 2. FIG. 7 shows a graphic user interface provided when selecting start investment of FIG. 4, and at this web page stock exchange can be directly executed while on line. FIG. 8 is a detailed flow chart illustrating stock exchange and information search of FIG. 4.

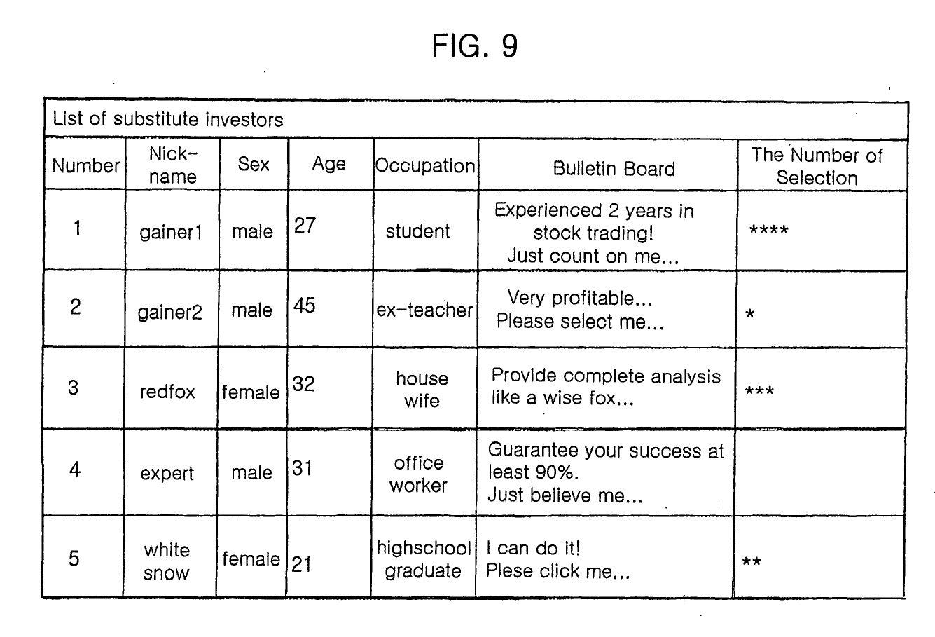

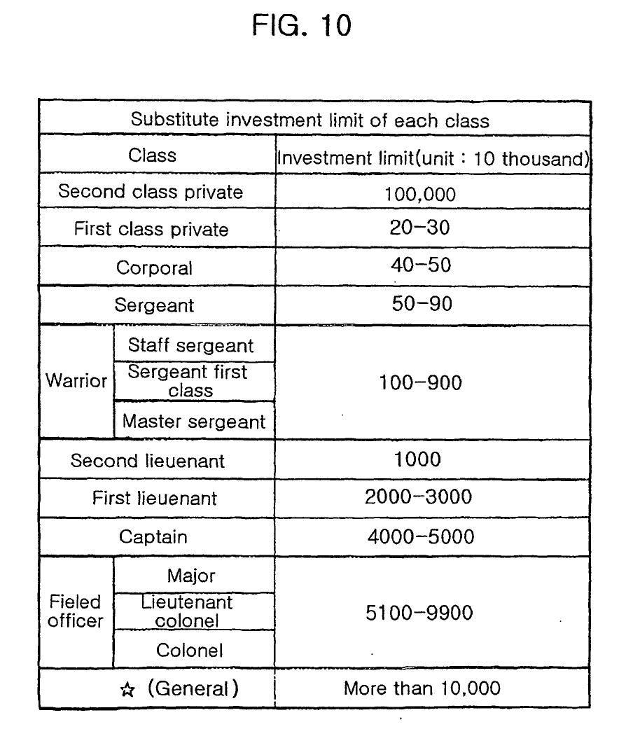

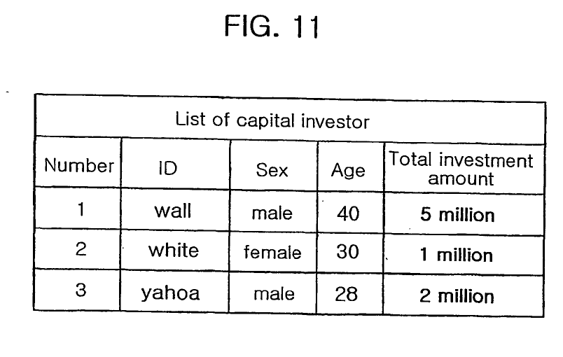

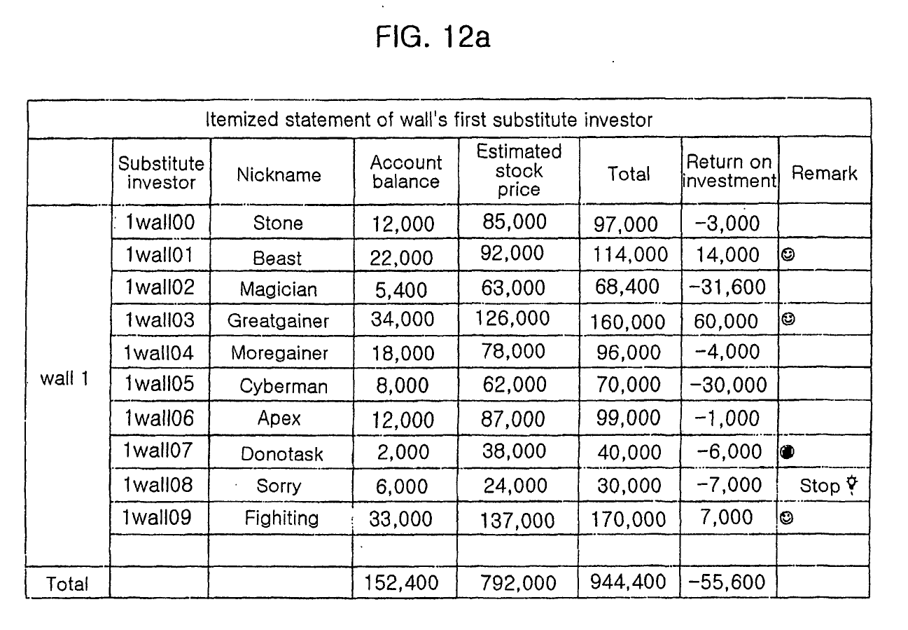

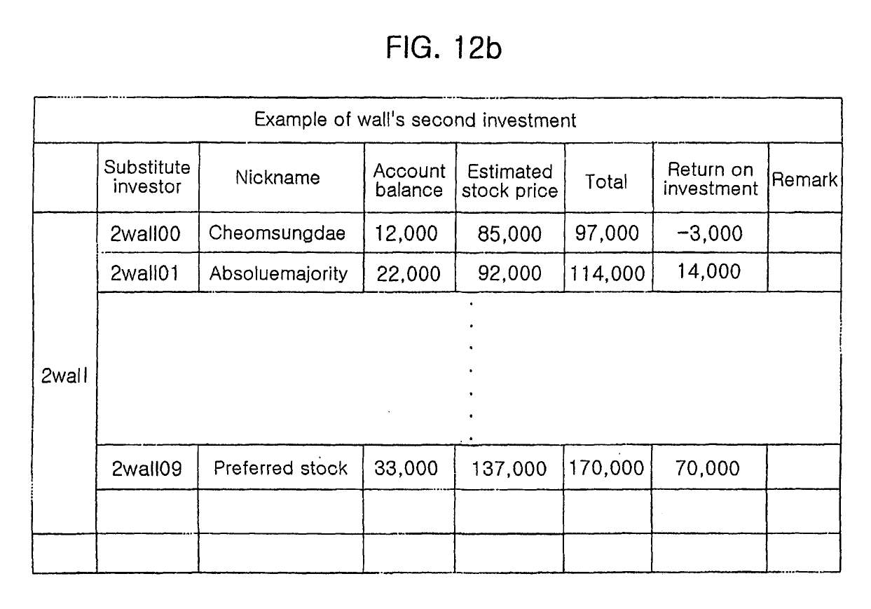

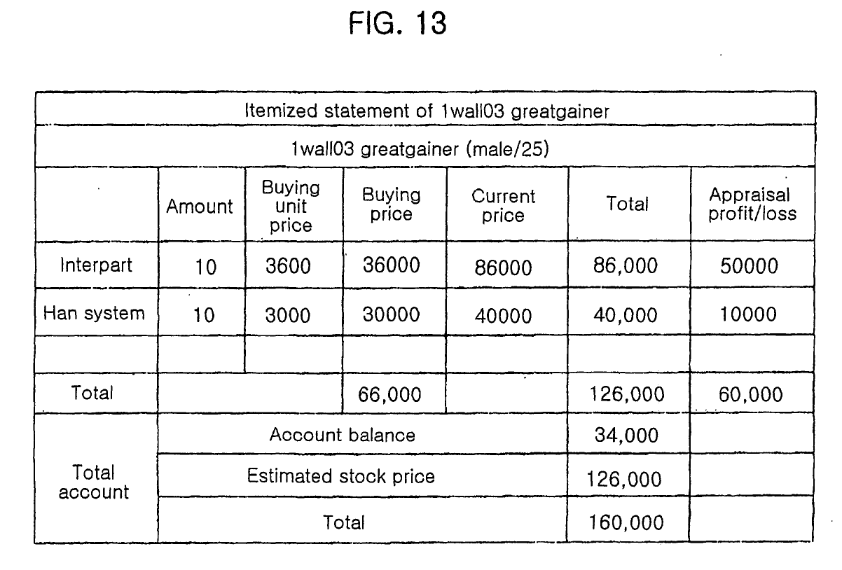

FIG. 9 is an exemplary list of substitute investors, where serial number, nickname, sex, age, occupation of substitute investors and bulletin information are provided. FIG. 10 is an exemplary list of limit of investment money of substitute investors who are categorized by the amount of investing money. FIG. 11 is an exemplary list of stock investors. FIGS. 12a and 12b are exemplary investment breakdown of substitute investors. FIG. 13 is an exemplary investment breakdown of sub-substitute investors.

The present invention is described in detail referring to attached drawings as follows.

The present invention relates to on-line stock exchange in cyberspace through the internet, and the invention is provided to minimize the risk of stock investment and to permit a beginner, who has little knowledge on stock trading, to invest money in stocks by registering a capital investor who has capital and a substitute investor who has time for trading, wherein said capital investor selects a plurality of substitute investors based on information on substitute investors.

Referring to FIG. 1 to FIG. 4, if a customer 21 accesses to the web server 32 of the stock exchange system 30 through the internet 10 at a first step S21, as shown in FIG. 5, said web server 32 provides web pages stored in the web information storage unit 35a of database 35.

Next, at the second step S22, if a customer has not registered at the new registration processing unit 33a of the stock exchange server 33 shown in FIG. 2, the new registration processing unit processes for a new registration, while if a customer has registered at the server, the server takes next step. To explain the process for registering a new customer in detail referring to FIG. 6, if a customer selects the new customer registration function of FIG. 5, a web page is provided in cooperation with the web server 32 and stock exchange server 33 (step S32a of FIG. 6), where a customer can input his/her identification information such as ID, password, account number and etc. (step S32b of FIG. 6). After being completed input, the identification information is stored at the customer information storage unit 35b of the database 35 under the control of the DB server 34 (referring to step S32c of FIG. 6).

After completing new customer registration, a registered customer can register himself/herself as a capital investor or as a substitute investor who has time for stock trading. Firstly, when registering as a capital investor, if a registrant selects the capital investor registration function, the web server 32 provides a web page for the registration, and at this page a registrant can input his/her ID, password, and then through confirmation process of registration information the customer who has said ID can be registered as a capital investor.

And also, a registrant can register himself/herself as a substitute investor following the same procedure described above, wherein said information on a capital investor is stored at the capital investor information storage unit 35c of the database 35 under the control of DB server 34 and information on a substitute investor is stored at the substitute investor information storage unit 35d of the database 35 under the control of DB server 34. And a substitute investor can input his/her nickname or another name together with the real name, which is necessary to protect private information and detailed explanation on this reason is described as follows.

And the third step S23 permits a registered customer to login to the program, wherein when a registered customer inputs his/her ID and password at the web page shown at FIG. 5, if the ID and password are identical with the customer's ID and password stored at the customer information storage unit 35b of database 35, the person is considered as a registered customer and permitted to use information and to trade stocks.

And at the forth step S24, S25, real-time stock exchange system is instigated at the request of investment start. Referring to FIG. 5, if a logged-in registrant orders investment start, the order is transferred to the web server 32, and according to this order, the web server 32 accesses to real-time stock exchange system of a predetermined or selected securities corporation providing a customer with a web page shown in FIG. 7 to permit stock exchange and at this time the web server 32 operates in cooperation with the stock exchange server 33 under the control of the host 31 of the stock exchange system 30, wherein the stock exchange server 33 operates in cooperation with real-time stock exchange system of a predetermined or selected securities corporation to enable stock trading at the request of a customer's order.

And the fifth step S26 comprises information search step for searching information on stocks and substitute investors, substitute investor appointment step for appointing a substitute investor, stock exchange step where a substitute investor appointed by a capital investor trades stocks, and substitute investor administration step where data on substitute investors of each capital investor is managed. Wherein the stock information processing unit 33b of the stock exchange server 33 of FIG. 2 can process information search, substitute investor registration and stock exchange following a customer's request order, and processing for substitute investor administration is done automatically.

Firstly, to explain about the information searching step S26a referring to FIG. 7 and FIG. 8, the web page of FIG. 7 provides stock related news, information on stock prices and ranking of return on investment, stock account search, capital investor search, substitute investor search. When a customer selects each search function, the inquiry is recognized by the stock exchange server 33 through the host 31, and relevant information is provided from pertinent data storage unit of the database 35 through DB server 34 and displayed on the web page.

To explain about a stock exchange step S26c, referring to FIG. 8, when placing an order for stock exchange, the server permits only a substitute investor, who has registered his/her ID and password and is appointed as a substitute investor by a capital investor, and the appointed substitute investor is permitted to trade stocks, search for information on stocks, input stock quantity to trade and price to sell or buy after selecting a stock item, confirm the input data, and complete the order. And from then on, a capital or substitute investor can check information on stock trading status at any time as well as search information on an investor and stock account of himself/herself.

And, in respect to inquiry on a substitute investor, when selecting substitute investor inquiry function, the order transfers to the web server 32, and the web server 32 provides a customer with a list of substitute investors as shown in FIG. 9.

As describe above, in respect to a substitute investor permitted to trade stocks at the server, to explain about the substitute investor appointment step where a capital investor appoints a substitute investor, firstly, if a capital investor requests for information on substitute investor, the web server 32 supplies a web page containing information on the substitute investor, which information is provided by the substitute investor information storage unit 35d of the database 35 through the DB server 34. And a capital investor selects one or a plurality of substitute investor(s) based on the information on substitute investor(s) and then pays predetermined capital to (a) selected substitute investor(s). As shown in FIG. 9, among information on a substitute investor, the name of a substitute investor is anonymous using nickname to protect the substitute investor's private life, but the real name can be displayed if a substitute investor's position is authorized enough, e.g. the position is higher than a predetermined grade.

As described above, a capital investor can select a plurality of substitute investors, and also a substitute investor can be selected by a plurality of capital investors, and to endow a substitute investor at the bottommost grade with an opportunity to trade stock, there can be an indispensable condition where a capital investor should select at least one bottommost graded substitute investor and an optional condition where a capital investor selects a substitute investor whose grade is higher than bottommost grade. And information on a substitute investor includes the number of capital investors who has appointed the substitute investor as his proxy displaying the number with a mark (e.g. asterisk mark *) to notify so that a capital investor can carefully appoint a substitute investor(s) referring to the prominence of a substitute investor. The number of times of selecting a substitute investor is not necessarily limited, but considering efficient investment, investment concentration and success probability, and endowing many substitute investors with more trade opportunity, it is preferable to restrict the frequency of selecting a substitute investor.

Meanwhile, in respect to the limit of investing money that a substitute investor can deal with, which is determined at the capital/substitute investor administration unit 33d of the stock exchange server 33 of FIG. 2, a substitute investor starts from the bottommost grade, and then the grade is re-appreciated reflecting the substitute investor's ROI (return on investment), wherein the grade is categorized from private to general by mimicking the military hierarchy as shown in FIG. 10.

To explain about said step of selecting substitute investor in detail, a capital investor can transfer money to any substitute investors, but to endow a few rudimentary substitute investors with trading opportunity, it is preferable to preferentially allocate part of capital to the rudimentary substitute investors and then to allocate the rest of capital to another substitute investor according to the grade categorized by the amount of investment money.

Said substitute investors, as shown FIG. 10, are categorized by amount of money to invest, therefore, a capital investor can use the grade as an objective reference to evaluate a substitute investor's experience and ROI.

The evaluation on said substitute investor's ROI can be conducted on a periodical or irregular basis, and when calculating increment and decrement of each substitute investor's ROI, if the degree of ROI increment surpasses the increment limit of a grade, the level of grade of a substitute investor goes up, and if the degree of ROI decrement surpasses the decrement limit of a grade, the level of grade of a substitute investor goes down. For example, if the increment of ROI is more than 100,000 won, the level of grade of a substitute investor moves one level up, and if the decrement of ROI is more than 100,000 won, the level of grade of a substitute investor moves one level down.

As described above, categorizing substitute investors based on his/her ROI provides a capital investor with objective information on substitute investor's trading capability.

When said substitute investor makes profit by proxy investment, the substitute investor has to pay a predetermined portion of the profit to his/her capital investor who appointed him/her as substitute investor because basically a substitute investor invests stocks with a capital investor's capital by proxy. Wherein the number of times of paying a predetermined portion of profit is not restricted, but it can be restricted to a predetermined times considering a substitute investor's profit.

Meanwhile, during said substitute investor administration step, if a substitute investor satisfies a qualification standard for being a capital investor, the substitute investor can be entitled to invest with his/her own capital, and a qualification standard for being a capital investor can be set in advance using more than one data on substitute investor's total account, ROI and grading up ratio. For example, if a substitute investor's performance satisfies a predetermined standard when evaluating the substitute investor's total account, ROI and grading up ratio on a periodical or irregular time basis, the substitute investor is entitled to be a capital investor, and from then on, the substitute investor can appoint a plurality of substitute investors.

By adopting the method for endowing a substitute investor with a capital investor's position when a substitute investor's ROI surpasses a predetermined standard, one capital investor can be connected to sub-substitute investors (substitute investors who is appointed by another substitute investor) such as secondary or tertiary substitute investors. According to this, a capital investor can be connected to a substitute investor horizontally and vertically (hierarchically), the present invention provides a model which can create limitless profit.

For example, to explain about a method of selecting a substitute investor referring to FIG. 11 and FIG. 12, when a capital investor wall1 of FIG. 11 invests a predetermined amount of money, e.g. 1,000,000 won, selecting 10 (ten) substitute investors 1wall00 to 1wall09, each of the 10 substitute investors is given 100,000 won respectively. Otherwise when the capital investor wall1 invests 5,000,000 won selecting 10 (ten) substitute investors 1wall00 to 1wall09, each of the 10 substitute investors is given 100,000 won respectively, and the rest of money 4,000,000 won is given to other substitute investors selected by the capital investor, e.g. when selecting 10 (ten) substitute investors who are entitled to invest up to 400,000 won (e.g. corporal grade), each of the 10 substitute investors is given 400,000 won respectively.

To explain about the relations between a capital investor and a substitute investor in detail referring to FIG. 11 to FIG. 13, any substitute investors can participate in the system, but only a substitute investor appointed by a capital investor can invest as a substitute investor. Taking an example of a substitute investor wall01 selected by a capital investor wall, when the capital investor selects 10 (ten) substitute investors wall00 to wall09, and each of the 10 substitute investors is given 100,000 won respectively. And detailed description is as follows.

1. At first a substitute investor wall01 belongs to second-class private grade and can invest 100,000 won.

2. If the substitute investor wall01 succeeds in investment increasing his/her account balance up to 200,000 won, the substitute investor is upgraded to first-class private class.

3. At this time, the substitute investor wall01 transfers 20,000 won, which is 10% of his/her account balance, to the capital investor wall.

4. If the substitute investor wall01 continuously succeeds in investment increasing his/her account balance up to 300,000 won, 400,000 won and 500,000 won, the substitute investor's grade will be up one grade at each time, and the substitute investor should pay the capital investor wall 10% of the account balance (30,000 won, 40,000 won, 50,000 won respectively), but the substitute investor pays the money to the capital investor wall up to a predetermined amount of money (e.g. 1,000,000 won).

5. By this time, the capital investor wall's income is 20,000 won, 30,000 won, 40,000 won, . . . , 100,000 won, of which total amount is 540,000 won, wherein the capital investor's investment profit is 440,000 won. By this method, if all of the substitute investors succeed in investment, the capital investor's total investment return is in total of 5,400,000 won, of which profit is 4,400,000 won in total.

6. If the substitute investor wall01 succeeds in investment to have account balance of 1,000,000 won, the substitute investor is entitled to be a capital investor and he/she is permitted to select 5 (five) substitute investors wall011 to wall015, wherein the substitute investor wall01 invests 500,000 won to sub-substitute investors and the rest of 500,000 won is net profit.

7. If secondary substitute investors (sub-substitute investors) wall011 to wall015 who were invested by the substitute investor wall01 succeed in investment using the same method described above, and transfer 10% of profit, i.e. 20,000 won, 30,000 won, . . . , 100,000 won, to the substitute investor wall01, the substitute investor wall01 should transfer 10% of his/her profit, i.e. 2,000 won, 3,000 won, . . . , 10,000 won to the capital investor wall.

8. For example, if 5 (five) of the secondary substitute investors succeed in investment, the substitute investor wall01 will receive 20,000 won, 30,000 won, . . . , 50,000 won from the secondary investors totaling 140,000×5=700,000 won. Therefore, the capital investor wall will get 70,000 won, which is 10% of 700,000 won.

According to the above method, the capital investor wall can consecutively get income from a secondary substitute investor who is derived from a substitute investor, when the secondary substitute investor succeeds in investment, the capital investor wall can get profit, which is greater than principal, by applying infinite profit principle, which guarantees some portion of profit derived from substitute investors' profit, even if a small number of substitute investors succeed in stock investment.

And to introduce capital investor's safe investment and substitute investor's careful investment, the criteria for disqualifying a substitute investor can be set in advance at said substitute investor administration step using at least one reference of total account balance, ROI, grade decrement ratio of a substitute investor, and if a substitute investor falls under the criteria, then a substitute investor can be disqualified, wherein the criteria on disqualification can be set in various ways. For example, a substitute investor can be disqualified if total account balance is less than a predetermined value, or ROI maintains −50% for a predetermined period, or a substitute investor's grade downs a level for three times or consecutively downs three times.

To explain again in detail about minimizing a capital investor's loss and encouraging a substitute investor's careful investment, if a substitute investor consecutively fails in investment, which leads to possessing only 30% of the minimum principal of capital, i.e. 30,000 won, the substitute investor is prohibited from investment, and the remaining money should be withdrawn, and the failure is recorded to the substitute investor's record. And one failure defers a substitute investor's qualification for a predetermined period, and it is marked on registration bulletin board. If a substitute investor fails three times, strike out comes into effect disqualifying the substitute investor, by which capital investors can be protected automatically. According to this, in case of a capital investor who invested 1,000,000 won, even if all of ten substitute investors fail in investment, the capital investor can save at least 300,000 won, which is 30% of his principal capital.

At last, the sixth step S27 determines whether exits the system or not. If there is no exit order, the flow goes back to the fifth step, otherwise disconnects to the web server.

The contents described above relates to a method for stock exchange via substitute investor in cyberspace wherein a capital investor of the present invention appoints a plurality of substitute investors so that the appointed substitute investors can invest with the capital investor's dispersed capital on behalf of the capital investor.

Industrial Applicability

According to the present invention as described above, a capital investor can invest in cyberspace appointing a plurality of substitute investors, and investment limit is decided according to substitute investor's grade. And a beginner who has little knowledge on stock exchange can participate in stock investment by appointing substitute investors wherein a substitute investor pays part of profit gained by his/her investment performance to a capital investor. And this system is especially effective in saving time spent for stock trading, preventing inattentiveness at a job site, and reducing anxiety caused by stock trading.

And investment risk can be reduced by appointing substitute investors, who are categorized by his/her investment performance, and the substitute investor's grade is adjusted after conducting evaluation on his/her trade performance.

The present invention described in relation to a preferred embodiment can be reconstructed and changed in many ways within the scope of the technical field provided by the claims of this invention by any person skilled in the art.

What is claimed is

1. A method for stock exchange via substitute investor in cyberspace, the method comprising:
a first step for accessing to a web server;
a second step for a non-registered customer to register and for a registered customer to proceed to a next step;
a third step for processing log-in of a registered customer;
a forth step for connecting to a real-time stock exchange system at the request of investment start;
a fifth step including information search step for searching stock related information and data on substitute investors, substitute investor appointment step for appointing substitute investor, stock exchange step for a substitute investor appointed by a capital investor to trade stocks, substitute investor administration step for administering trading information of substitute investor of each capital investor; and
a sixth step for determining exit, where if there is no exit order, the flow goes back to said fifth step, otherwise finishes connecting to the web server.

2. The method for stock exchange via substitute investor in cyberspace of claim 1, wherein the second step is characterized in further including a step of registering a customer as capital investor or substitute investor.

3. The method for stock exchange via substitute investor in cyberspace of claim 2, wherein the step of registering a customer as capital investor or substitute investor is characterized in endowing the substitute investor with an investment grade.

4. The method for stock exchange via substitute investor in cyberspace of claim 3, wherein the step of registering a customer as capital investor or substitute investor is characterized in entitling the investment grade of substitute investors with military class system.

5. The method for stock exchange via substitute investor in cyberspace of claim 1, wherein said forth step is characterized in providing a web page, displayed at the response of investment start order, showing stock related news, stock prices and ranking ROI's.

6. The method for stock exchange via substitute investor in cyberspace of claim 1, wherein said fifth step for searching information is characterized in further including searching information on a capital investor, substitute investor and account balance.

7. The method for stock exchange via substitute investor in cyberspace of claim 1, wherein the substitute investor appointment step of said fifth step is characterized in providing information on a substitute investor at the request of a capital investor, selecting one or a plurality of substitute investor(s) based on the information, and wiring predetermined amount of capital to appointed substitute investor(s).

8. The method for stock exchange via substitute investor in cyberspace of claim 7, wherein the substitute investor appointment step of said fifth step is characterized in having an indispensable condition of appointing one or more substitute investors who are at the bottommost grade and having an optional condition of appointing other substitute investors who are at other than the bottommost grade.

9. The method for stock exchange via substitute investor in cyberspace of claim 1, wherein the stock exchange step of said fifth step is characterized in further including
a step of inputting customer's ID and password
a step of permitting the customer to trade stocks if the customer's ID and password are authorized as substitute investor appointed by a capital investor;
a step of searching stock items to select a stock item selecting a stock item after searching stock items;
a step of inputting quantity and trading price for the selected stock item to request stock tradings;
a step of processing stock trading according to the completed request of stock trading; and
a step of confirming a trading result according to the trading request.

10. The method for stock exchange via substitute investor in cyberspace of claim 1, wherein substitute investor administration step of said fifth step is characterized in further including
a step of calculating increment or decrement in ROI of each substitute investor;
a step of entitling a substitute investor to upper grade when the substitute investor's ROI increment is surpassing a predetermined upper limit; and
a step of entitling a substitute investor to lower grade when the substitute investor's ROI decrement is surpassing a predetermined lower limit,
wherein the step of calculating and the step of entitling is conducted on a periodical.

11. The method for stock exchange via substitute investor in cyberspace of claim 10, wherein said substitute investor administration step is characterized in further includs a step of paying a predetermined portion of profit resulted from each substitute investor's investment to a capital investor who invested his/her capital.

12. The method for stock exchange via substitute investor in cyberspace of claim 11, wherein said substitute investor administration step is characterized in further including a step of setting investment limit at each grade.

13. The method for stock exchange via substitute investor in cyberspace of claim 12, wherein said substitute investor administration step is characterized in setting in further including a step of setting in advance the frequency of paying a predetermined portion of profit to the capital investor.

14. The method for stock exchange via substitute investor in cyberspace of claim 13, wherein said substitute investor administration step is characterized in setting a standard for disqualifying substitute investor in advance based on more than one references of total account balance, ROI, and grade decrement ratio,
and disqualifying substitute investor if a substitute investor falls under said disqualifying standard.

15. The method for stock exchange via substitute investor in cyberspace of claim 14, wherein said substitute investor administration step is characterized in further including a step of setting a standard for qualifying capital investor in advance based on more than one references of total account balance, ROI, and grade increment ratio
to qualify a substitute investor as capital investor if the substitute investor falls under said qualifying standard.

16. The method for stock exchange via substitute investor in cyberspace of claim 15, wherein said substitute investor administration step is characterized in that the substitute investor, who is qualified as capital investor can appoint a plurality of sub-substitute investors,
and each sub-substitute investors, who are categorized as secondary substitute investors or tertiary substitute investors and invested by the substitute investor, are paid a predetermined amount of profit by said substitute investor.
